(19) United States
(12) Patent Application Publication
(10) Pub. No.: US 2004/0267384 A1
(43) Pub. Date: Dec. 30, 2004

(54) Integrated console and controller

(75) Inventors: Wei Yen, Los Altos Hills, CA (US); William Saperstein, San Carlos, CA (US); John Princen, Cupertino, CA (US)

Correspondence Address: SWERNOFSKY LAW GROUP PC, P.O. BOX 390013, MOUNTAIN VIEW, CA, 94039-0013, US

(73) Assignees: BroadOn Communications, Inc., Palo Alto, CA; iQue Ltd., Palo Alto, CA

(21) Appl. No.: 10/670,129

(22) Filed: Sep. 23, 2003

Related U.S. Application Data
(63) Continuation-in-part of application No. 10/360,827, filed on Feb. 7, 2003.

(51) Int. Cl. G05B 19/18

(52) U.S. Cl. 700/65; 700/66

(57) ABSTRACT

The invention includes a method and system combining the capabilities of a console and controller, having a hand-held form factor including a removable and re-writable cartridge that can be inserted, using a processor capable of general purpose processing. The software can be upgraded, possibly dynamically. Dynamic upgrades can occur in real time. The processor has links to supplemental consoles, and supports multiplayer games. The communication link is coupled to a PC workstation or network router, and supports interactive communication. Multiplayer games can include players in remote locations. Games can include contests among multiple players, and among teams of players.

### BACKGROUND OF THE INVENTION

1. Field of the Invention

The invention relates to an integrated console and controller, such as for example might be used with a gaming system using a television as a display unit.

2. Related Art

Some computing devices are designed to be used with a television as their display unit, with the effect that the computing device can be sold separately from its display and therefore relatively inexpensively. Known systems include consoles for arcade-like games, which have the capability of presenting an audio and video output to the television, and receiving inputs from a hand-held controller.

One difficulty with known systems is that they can be bulky or unwieldy when coupled to the television, with the effect that they can be relatively difficult to move around, such as for example to another television at another location. The “TV Games” video game system, described at www.jakkstvgames.com, appears to include a system in which a controller is included within the game console, with the effect that the game console can be coupled directly to the television. While this system appears to achieve the goal of making the system less bulky, it is subject to several drawbacks. The system appears directed to a specific emulator included within a game console that looks like a legacy television game. This has the effect that it does not provide for alternative games playable using the game console or for upgrades to the games playable using the game console. This also has the effect that it does not provide for multiplayer interaction or for interaction between a local player and a remote device.

Accordingly, it would be advantageous to provide a method and system not subject to drawbacks of known systems.

### SUMMARY OF THE INVENTION

The invention provides a method and system capable of combining the capabilities of a console and controller, having a hand-held form factor that includes a cartridge that can be inserted or removed (and possibly including a rewritable storage element such as a “flash” memory), and using a computing device capable of general purpose processing, such as for example a secure processor such as described in earlier patent applications, as described herein as the “incorporated disclosure.” Providing the removable storage element has the effect that software can be upgraded or replaced, including the possibility of that software being dynamically upgraded or replaced. In embodiments where the storage element is rewritable, that software might be dynamically upgraded or replaced without involving a second cartridge. The computing device also includes additional communication links to supplemental consoles, with the effect that the method and system can support multiplayer games and games with multiple consoles. In one embodiment, the communication link can be coupled to a PC workstation or to a network router, with the effect that the method and system can support interactive communication with the effects that (1) dynamic upgrades can be performed substantially in real time, (2) multiplayer games can include players in substantially remote locations, and (3) games can include contests among multiple players for “high score” and the like, and can also include associations of players, such as for example player teams.

After reading this application, those skilled in the art would recognize that the techniques described herein provide an enabling technology, with the effect that heretofore advantageous features can be provided that heretofore were substantially infeasible.

### BRIEF DESCRIPTION OF THE FIGURES

FIG. 1 shows a block diagram of a system including a television and an integrated console/controller with a removable storage element, optionally including one or more supplemental consoles, optionally including a workstation, and optionally including one or more remote players.

FIG. 2 shows a block diagram of an example integrated console/controller.

FIGS. 3A-3AJ (collectively referred to herein as FIG. 3) show a design of an example integrated console/controller.

### INCORPORATED DISCLOSURES

This application claims priority of the following documents, each of which is hereby incorporated by reference as if fully set forth herein.

U.S. patent application Ser. No. 10/360,827, filed Feb. 7, 2003, attorney docket number 196.1006.01, titled “Secure and Backward-Compatible Processor and Secure Software Execution Thereon,” and all applications claiming priority thereof.

These documents are hereby incorporated by reference as if fully set forth herein, and are sometimes referred to herein as the “incorporated disclosure”.

Inventions described herein can be used in combination or conjunction with technology described in the incorporated disclosure.

### DETAILED DESCRIPTION OF THE PREFERRED EMBODIMENT

Preferred embodiments of the invention are described herein, including preferred device coupling, device functionality, and process steps. After reading this application, those skilled in the art would realize that embodiments of the invention might be implemented using a variety of other techniques not specifically described herein, without undue experimentation or further invention, and that such other techniques would be within the scope and spirit of the invention.

Lexicography

The following terms refer or relate to aspects of the invention or its embodiments. The general meaning of each of these terms is intended to be illustrative and in no way limiting.

The term “console” generally describes any device capable of delivering control inputs, either directly or indirectly, from a user to a controller of a game system or similar system. As described below, a console might include an integrated console/controller, which can perform both the functions of a console and of a controller, or might include a secondary console, which can perform the functions of a console. The concept of a console is broad, and includes any manner of user input device, possibility including a keyboard or keypad, joystick or mouse or other pointing device, or other control buttons, whether pre-selected or dynamically presented using a flat-panel controller, and the like. The console might include a direct wire connection, a direct RF or IR connection, or an indirect (switched) connection.

The term “controller” generally describes any device capable of receiving control inputs, either directly or indirectly, from a user of a console of a game system or similar system, and capable of providing a set of outputs that can be coupled to a display element, such as for example a television. As described below, a controller might include an integrated console/controller, which can perform both the functions of a console and of a controller. The concept of a controller is broad, and includes any manner of computing device, possibility including a general purpose computing device (or operating in combination or conjunction with a general purpose computing device), such as for example a PC workstation.

The term “rewritable storage element” generally describes any device capable of maintaining information for use by an integrated console/controller, and capable of being removed, replaced, or rewritten with new information. As described below, a rewritable storage element might include a flash memory. The concept of a rewritable storage element is broad, and includes any manner of storage device capable of being read and written, whether random access or not, and whether the read or write operations are relatively rapid or not. For some examples, not intended to be limiting in any way, the rewritable storage element might include an SRAM, flash memory, bubble memory, or disk drive (magnetic or optical or both). In one embodiment, the size of the rewritable storage element is about 1 inch by 2 inches, but there is no specific requirement for that particular size. Moreover, it is also possible for the rewritable storage element to include a relatively small transceiver of about 1 inch by 2 inches with which it exchanges information with the integrated console/controller, while the main body of the rewritable storage element is maintained elsewhere and has a different size.

The phrase “secure processor” generally describes any device that can use information from a rewritable storage element, and can operate as a relatively secure computing device performing the functions of a controller for a game system or similar system. As described below, the secure processor is relatively secure against tampering, with the effect that other elements of the system are capable of communicating privately and securely with the secure processor. The concept of a secure processor is broad, and includes any general purpose or special purpose computing device for which there is at least some secure memory, secured against inspection or intrusion from outside the secure processor, and for which there is at least some executive control capable of preventing application software from disclosing the contents of that secure memory. In one embodiment, the secure processor has at least some built-in security software that cannot readily be circumvented.

The terms “replace,” “update,” and “upgrade,” generally describe any method that can alter, amend, change, erase, or otherwise modify information received from the rewritable storage element. The concept of replacing, updating, or upgrading information on the rewritable storage element is broad, and includes both (a) electronic replacement of information stored on the rewritable storage element, and (b) physical replacement of the rewritable storage element with another rewritable storage element having distinct information stored thereon. The terms “dynamic” and “dynamically,” when used in reference to concept of replacing, updating, or upgrading information, generally describe any method by which those steps of concept of replacing, updating, or upgrading information are performed relatively quickly relative to operation of the game system or similar system.

The phrase “supplemental console” generally describes any device that can operate as a console, but which is supplemental to the integrated console/controller. The concept of a supplemental console is broad, and includes both (a) devices only able to act in combination or conjunction with the integrated console/controller, and (b) device that are able to act independently of the integrated console/controller, but subordinate themselves to control by the integrated console/controller in the presence of the latter. For one example, not intended to be limiting in any way, a second integrated console/controller which defers to the first integrated console/controller can perform the function of a supplemental console.

The phrases “multiplayer games” and “games with multiple consoles” generally describe any game system or similar system in which more than one player or more than one console is involved. In one embodiment, multiple players act concurrently at separate consoles, but there is no particular requirement therefore. Moreover, a game system or similar system in which a single player operates more than one such console is considered a multiplayer game or a game with multiple consoles in this application.

The scope and spirit of the invention is not limited to any of these definitions, or to specific examples mentioned therein, but is intended to include the most general concepts embodied by these and other terms.

System Elements

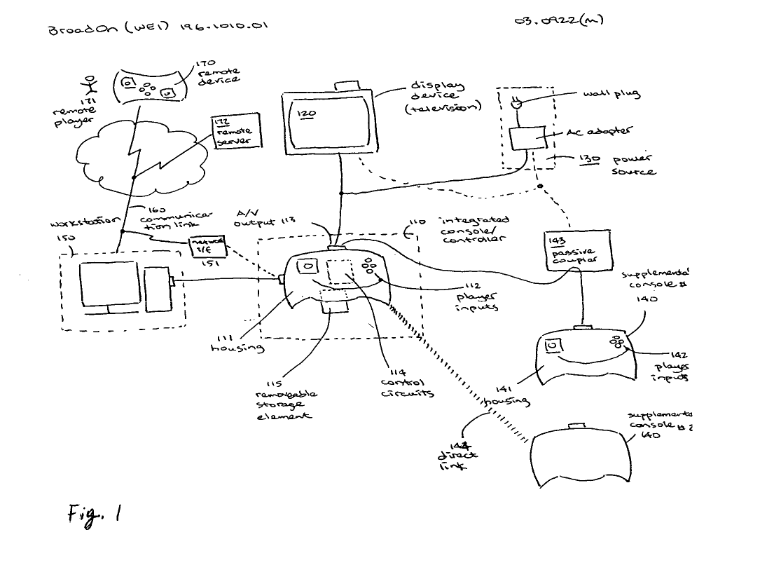

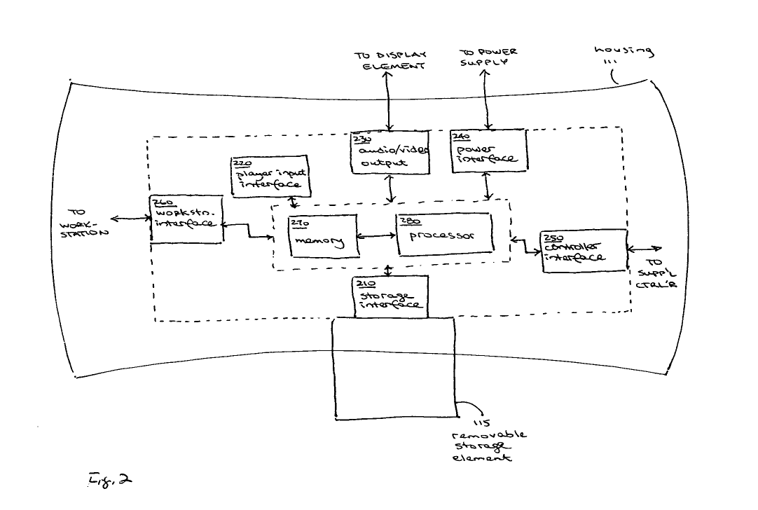

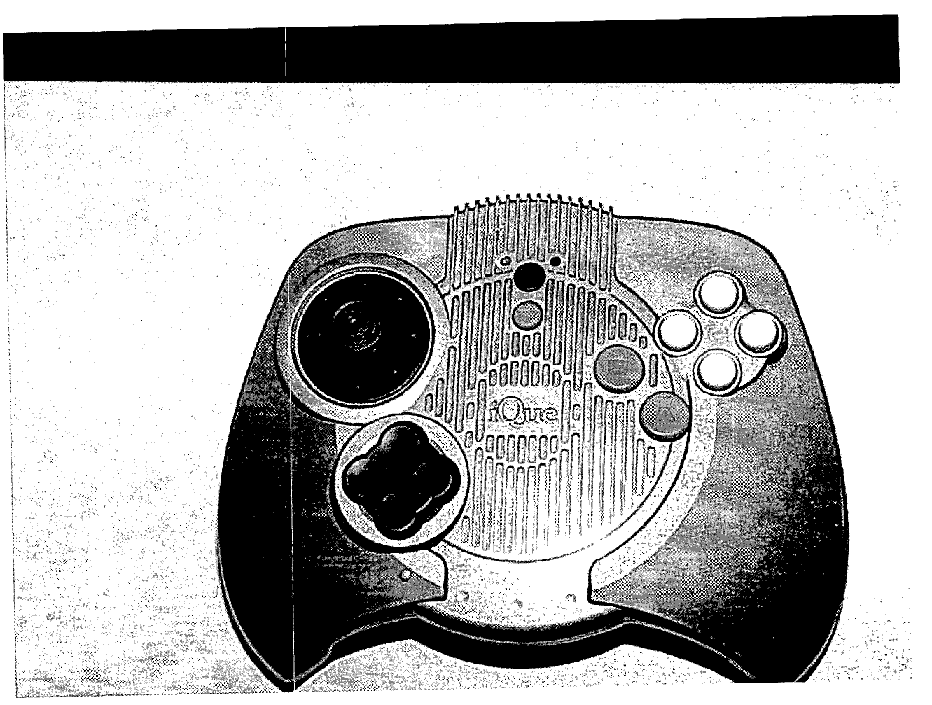

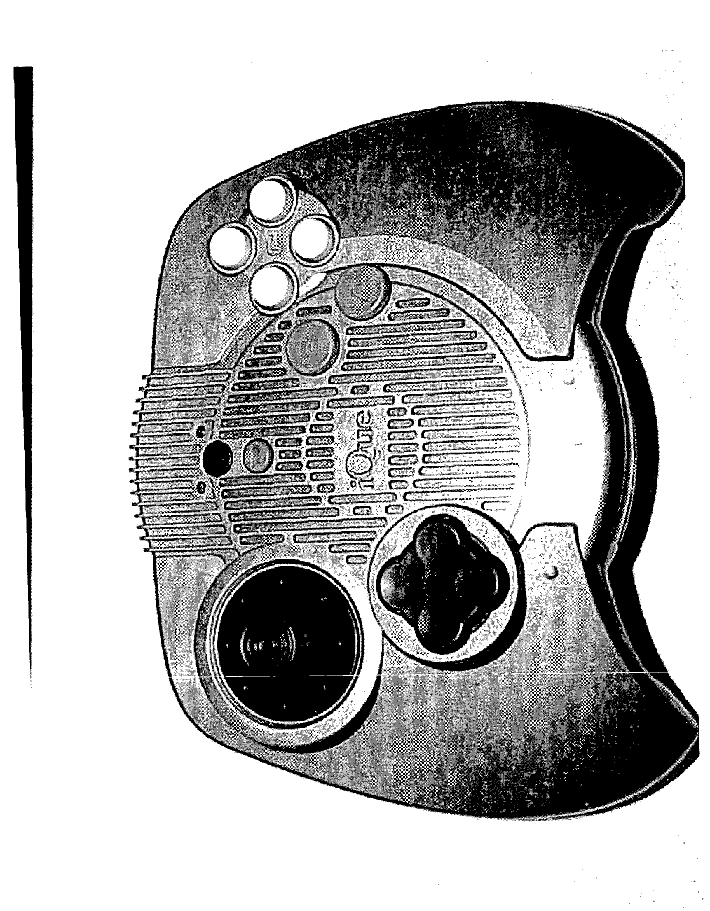

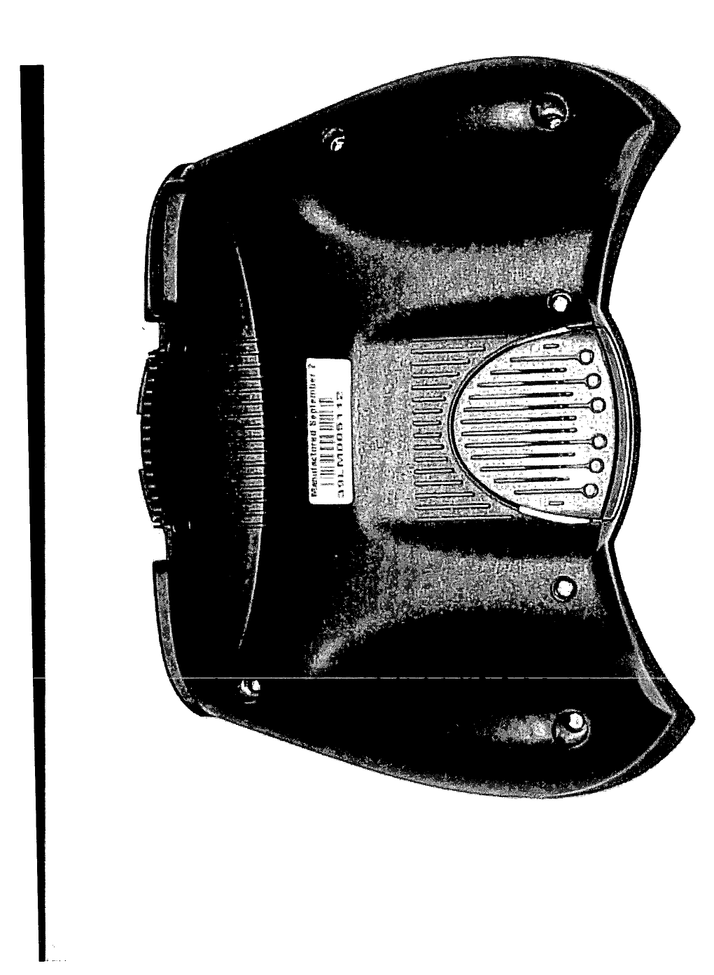

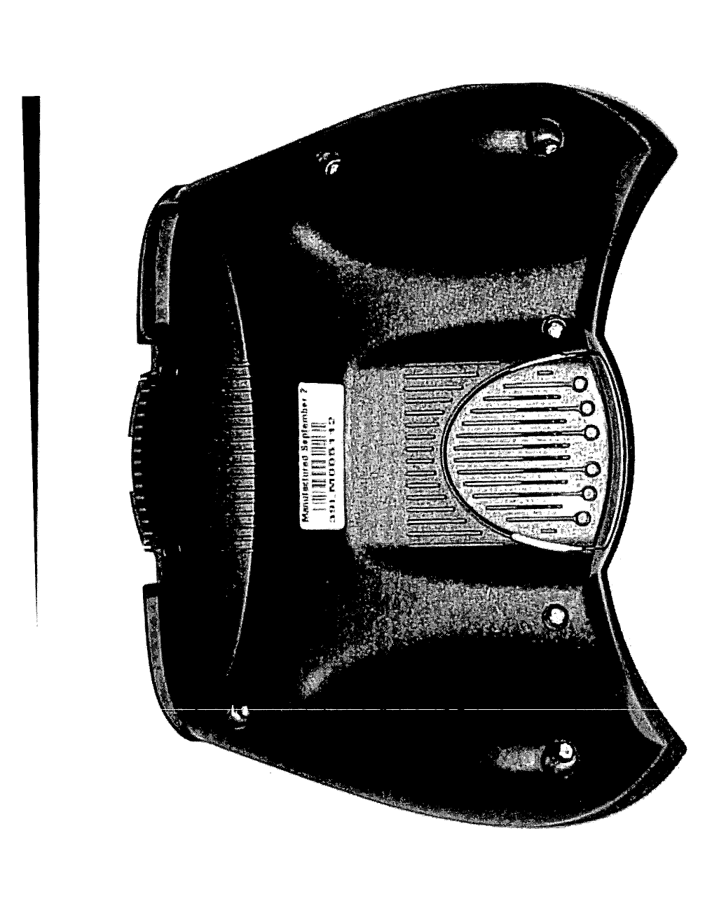

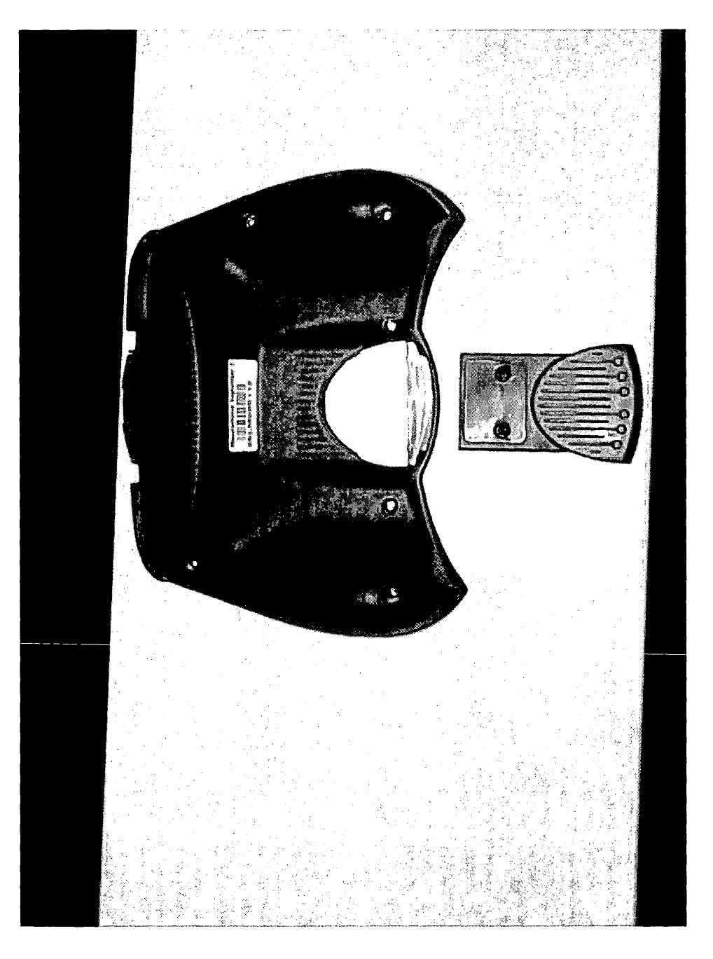

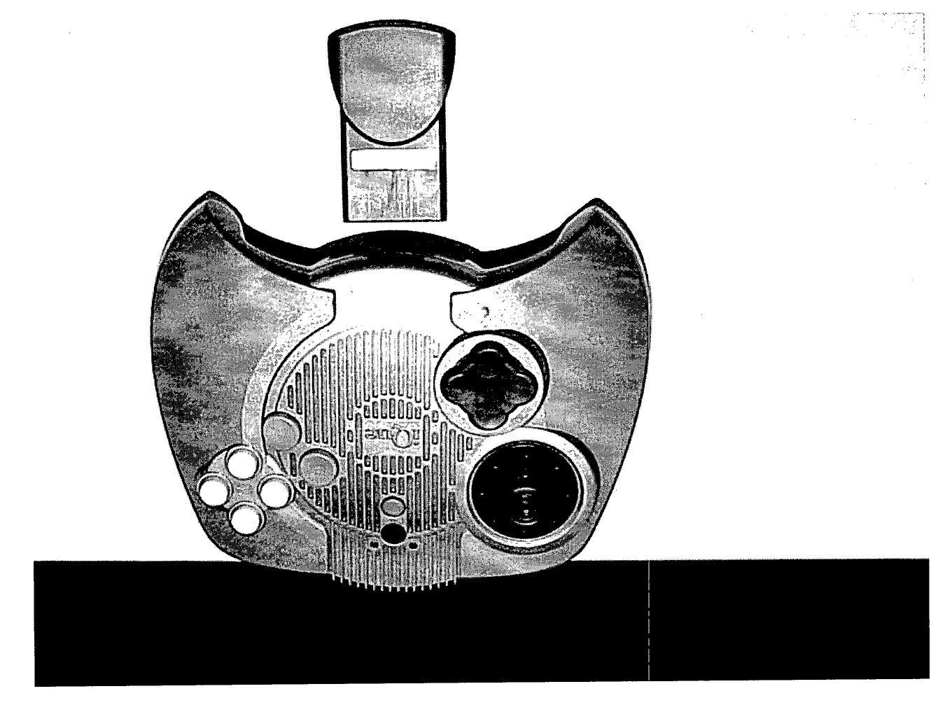

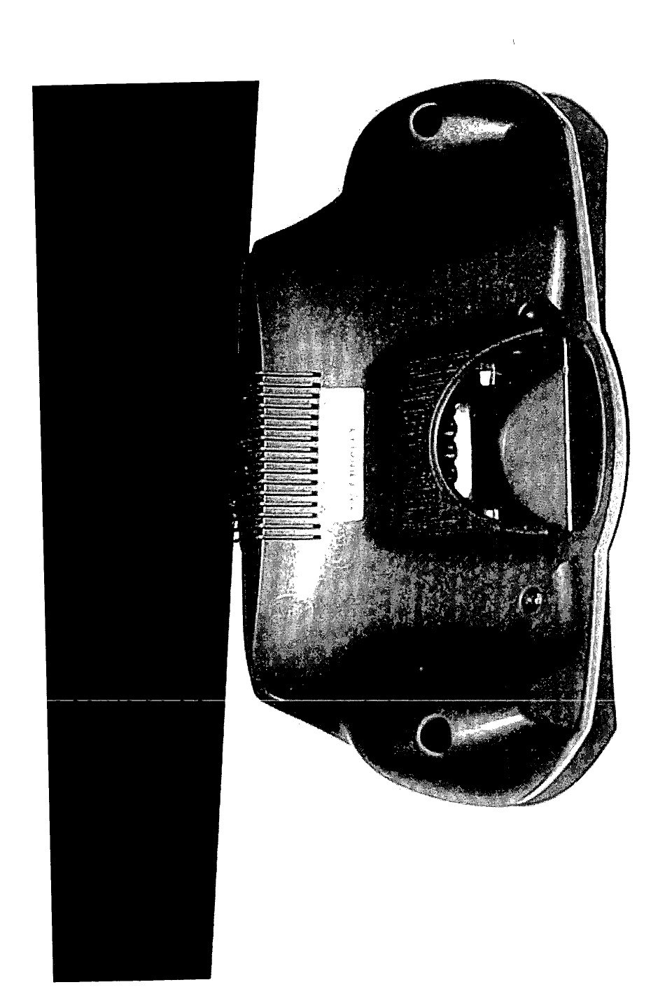

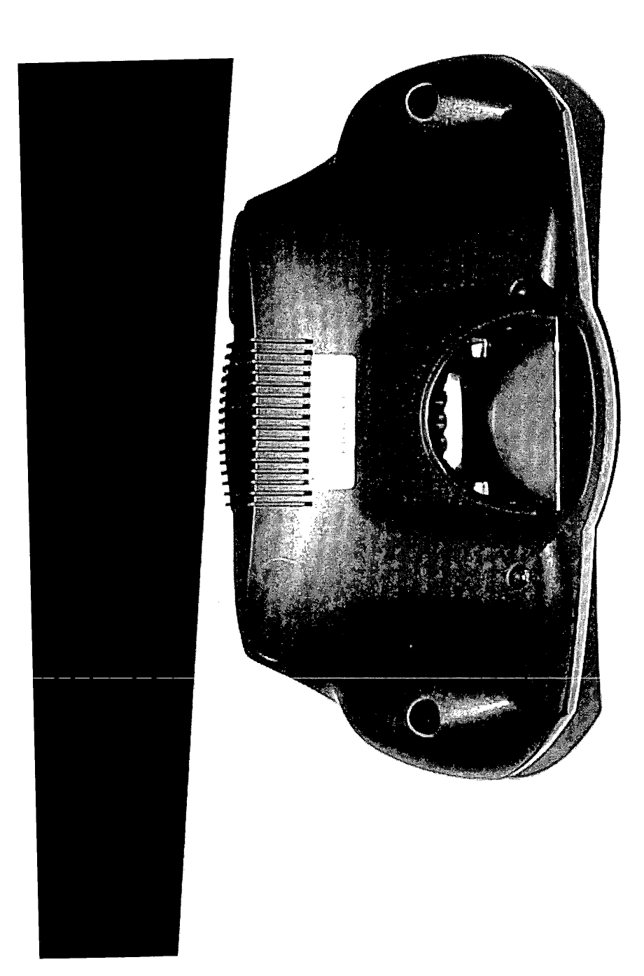

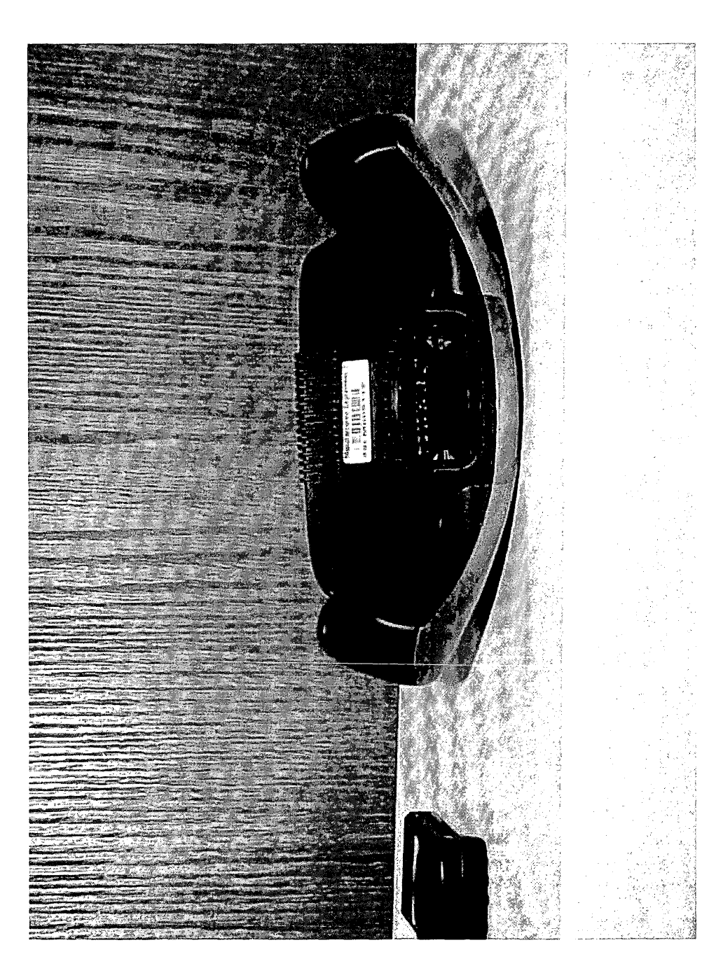

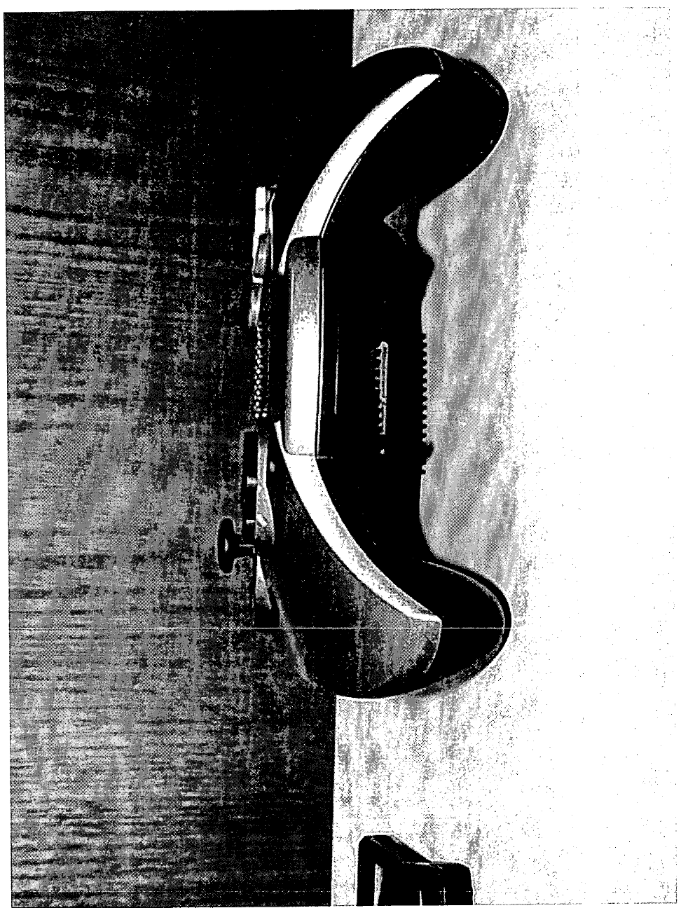

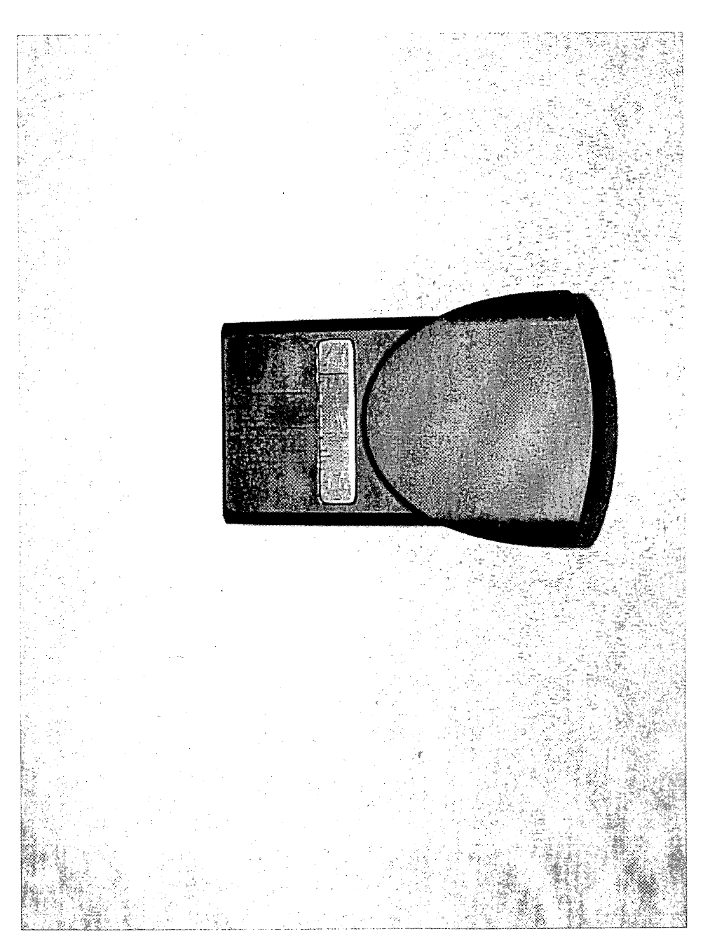

FIG. 1 shows a block diagram of a system including a television and an integrated console/controller with a removable storage element.

A system 100 includes an integrated console/controller 110, capable of being coupled to a television or other display device 120 and to an optional power source 130.

Integrated Console/Controller

The integrated console/controller 110 includes a handheld controller housing 111, a set of player inputs 112, an audio/video output 113, a set of control circuits 114, and a removable storage element 115.

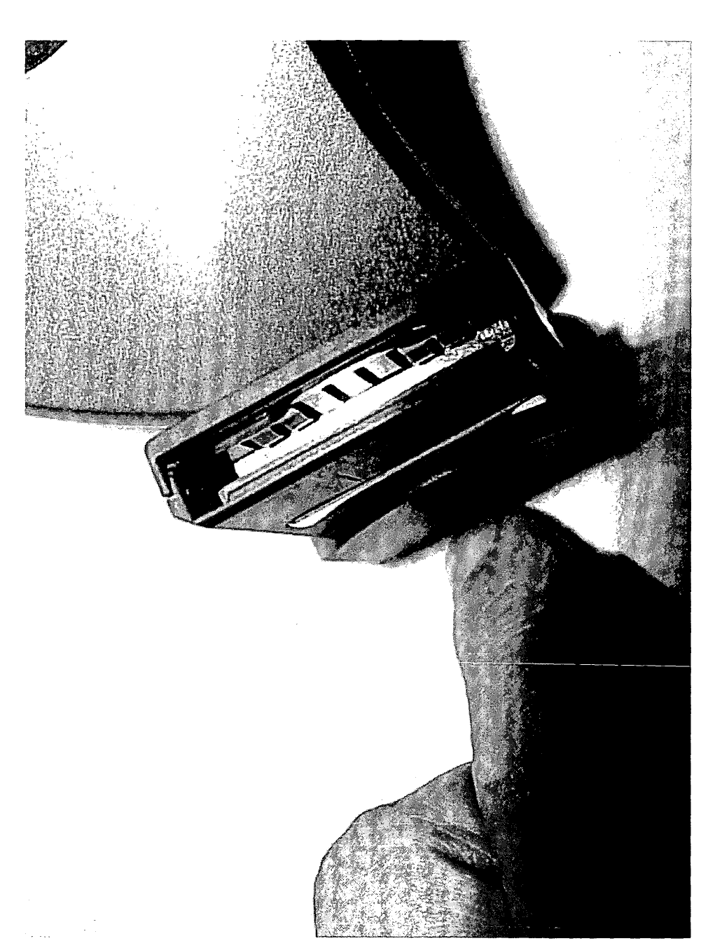

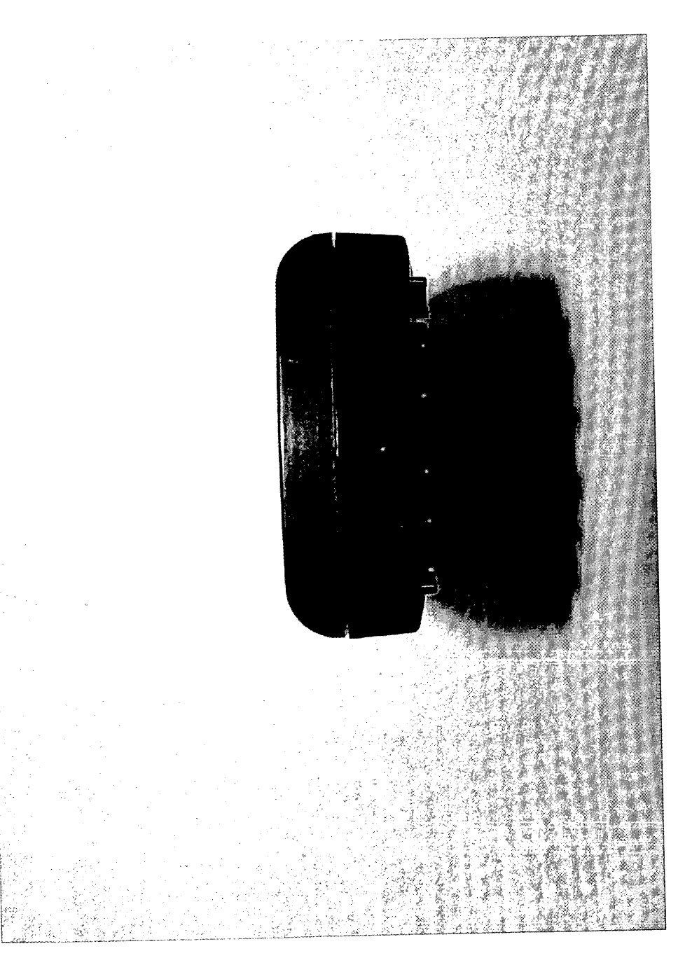

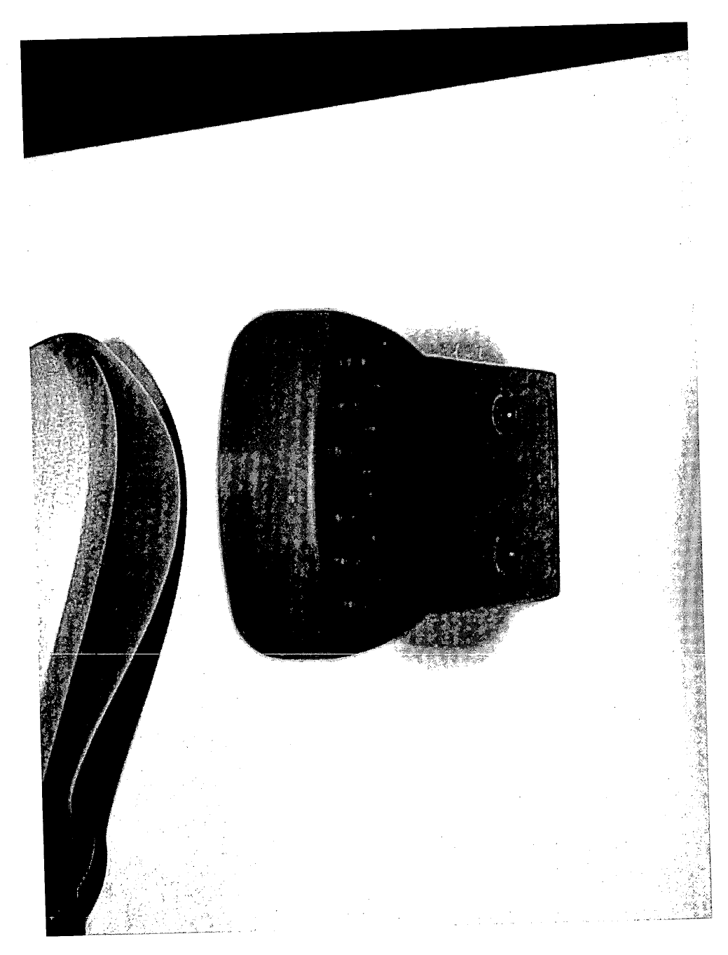

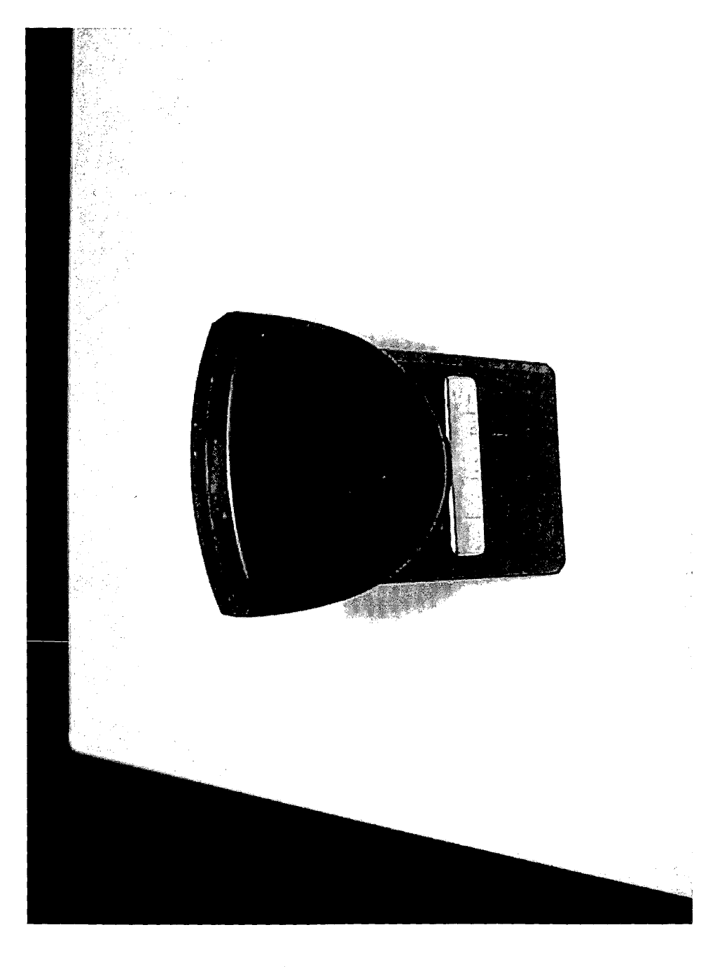

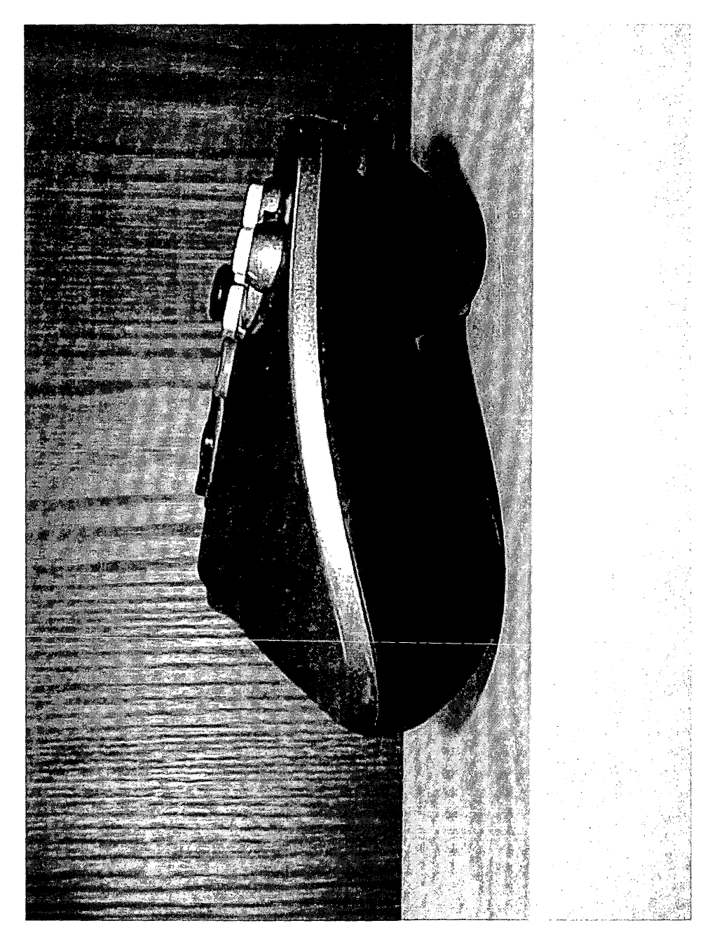

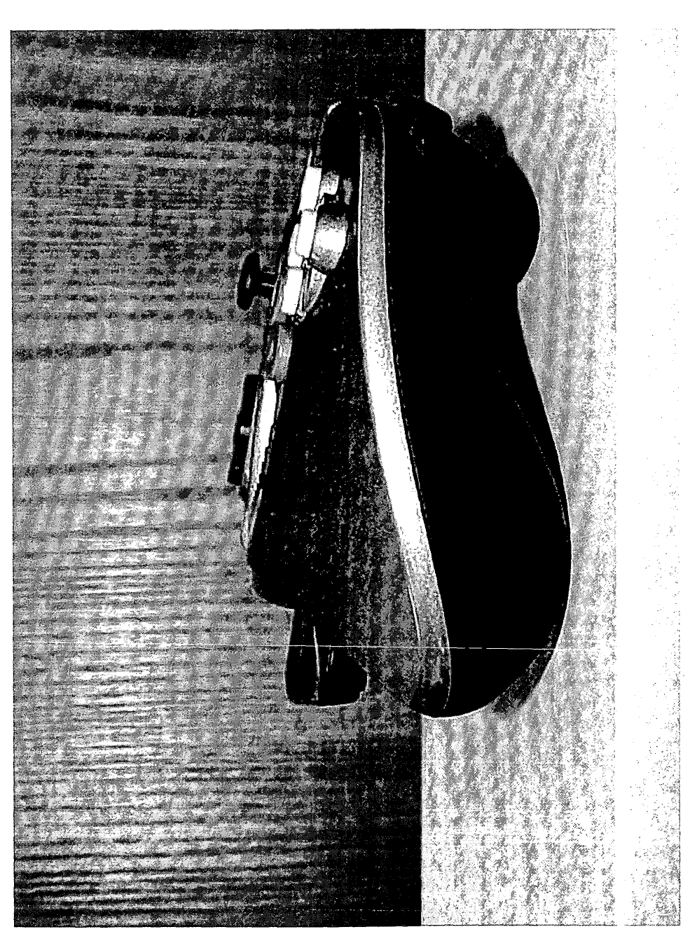

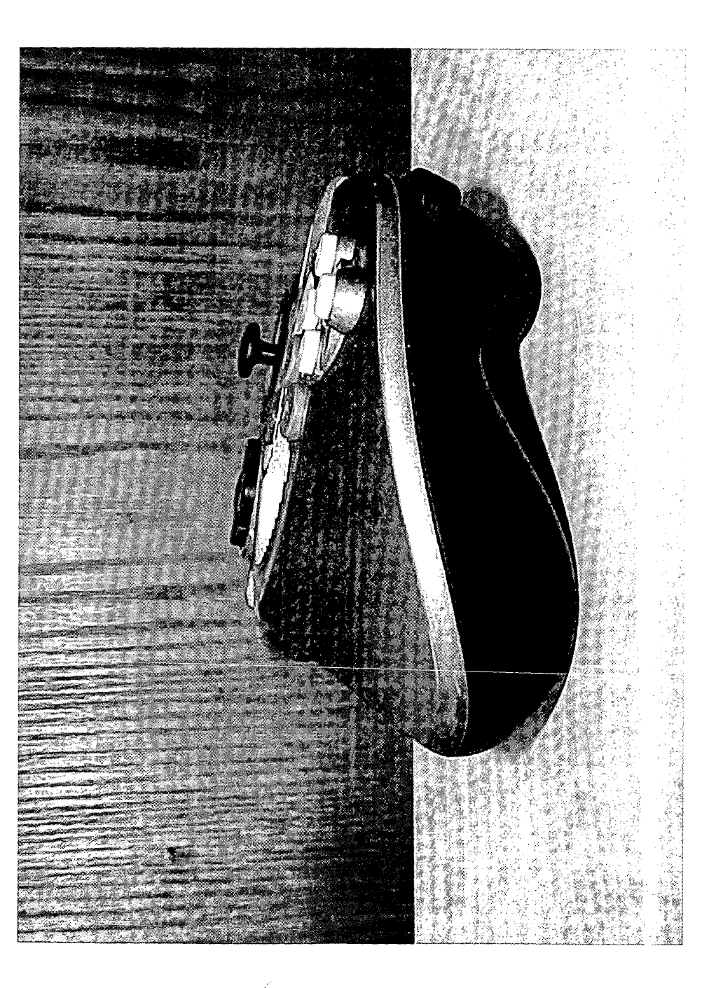

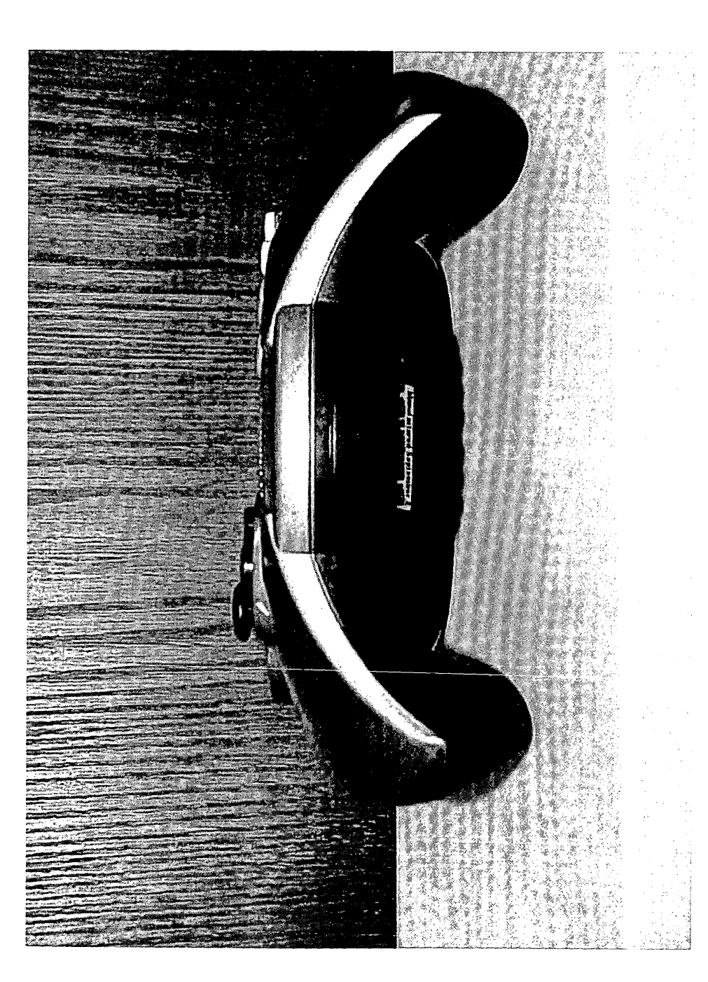

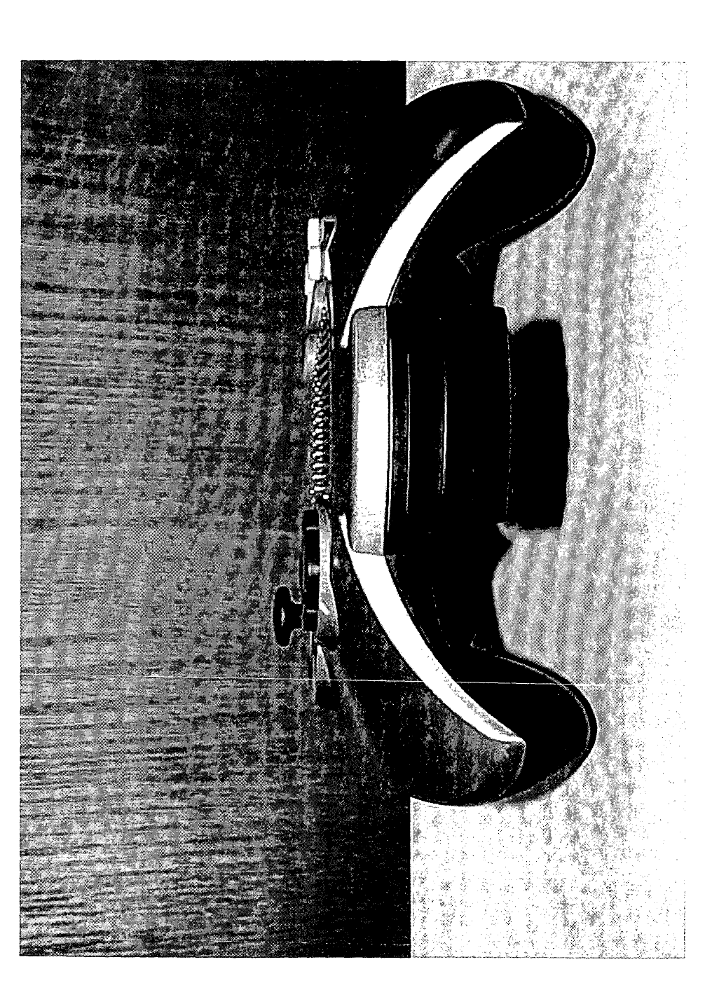

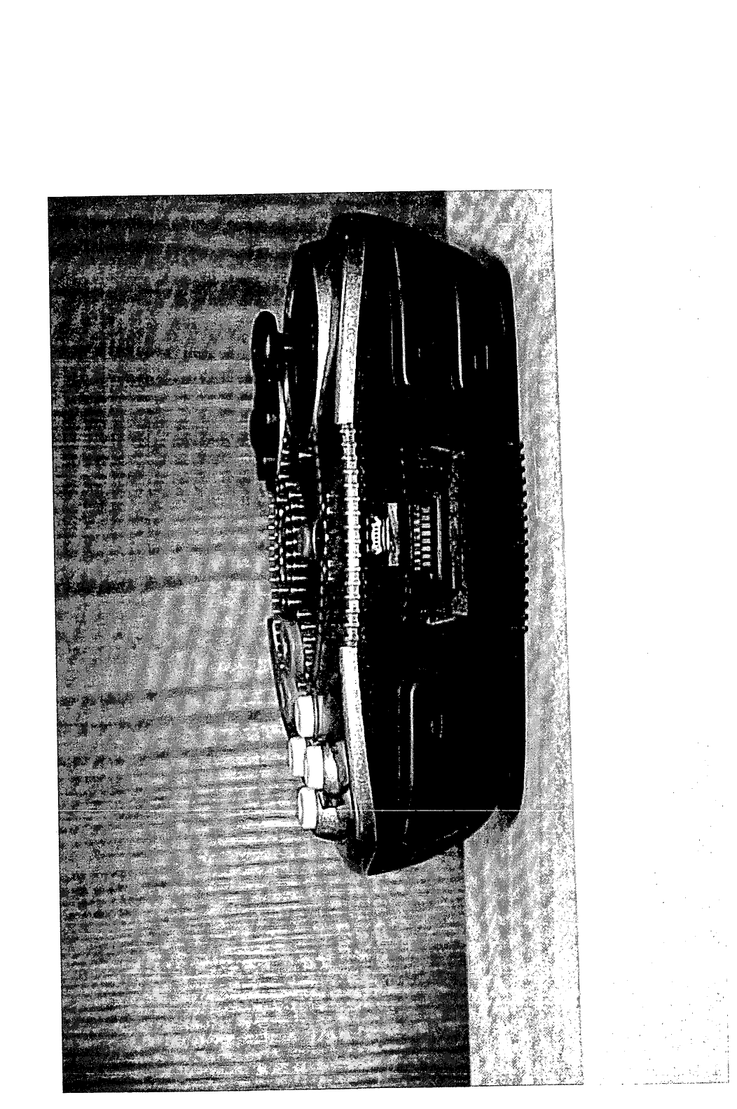

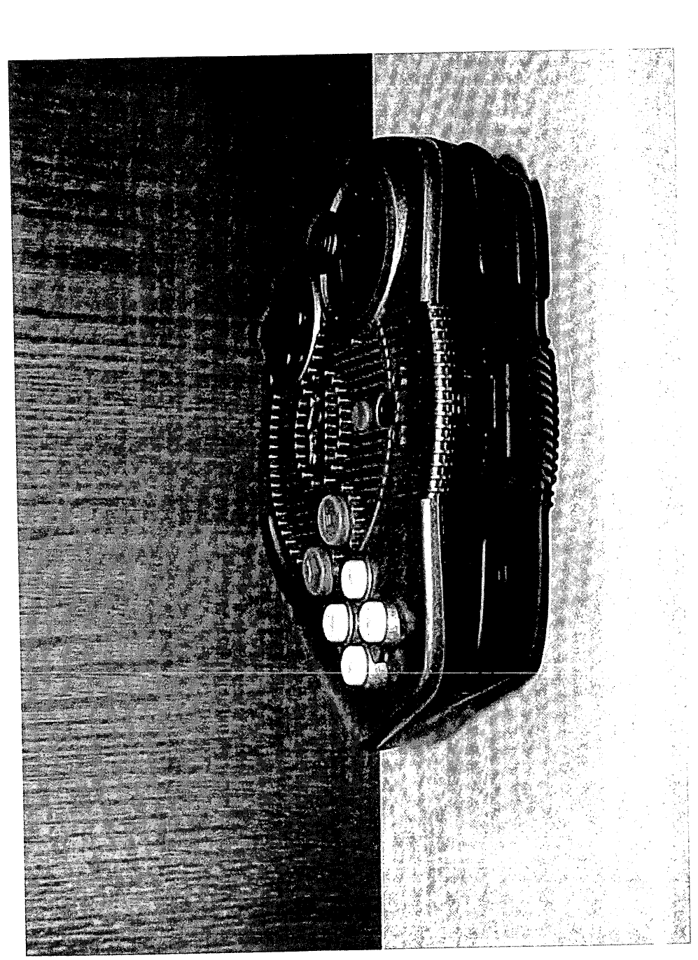

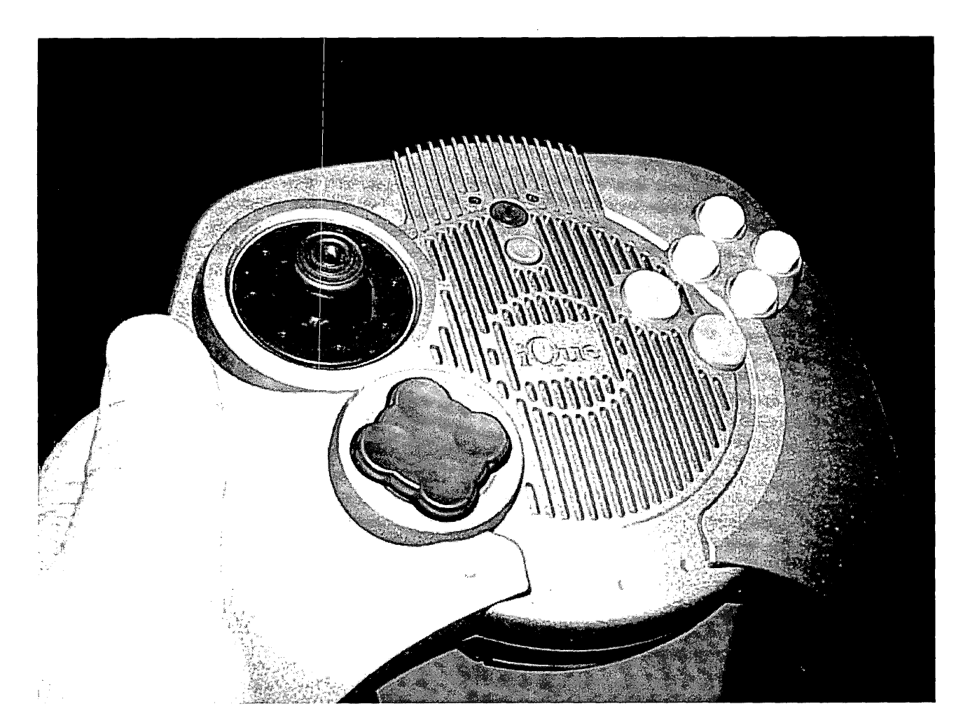

The handheld controller housing 111 and player inputs 112 are further described herein with reference to FIG. 3.

The audio/video output 113 is coupled between the integrated console/controller 110 and the display device 120.

In one embodiment, the audio/video output 113 is also coupled to the optional power source 130, and includes a power coupling, such as for example an AC adapter usable with an AC power source such as a home power outlet. However, there is no particular requirement that the audio/video output 113 involves a power coupling. In alternative embodiments, power might be supplied to the integrated console/controller 110 by battery storage or another power source.

In one embodiment, the audio/video output 113 can communicate a set of audio signals and a set of video signals from the integrated console/controller 110 to the display device 120. However, there is no particular requirement that audio/video output 113 involves any audio signals. In alternative embodiments, audio outputs might be provided directly by the integrated console/controller 110 using a speaker or another audio output device.

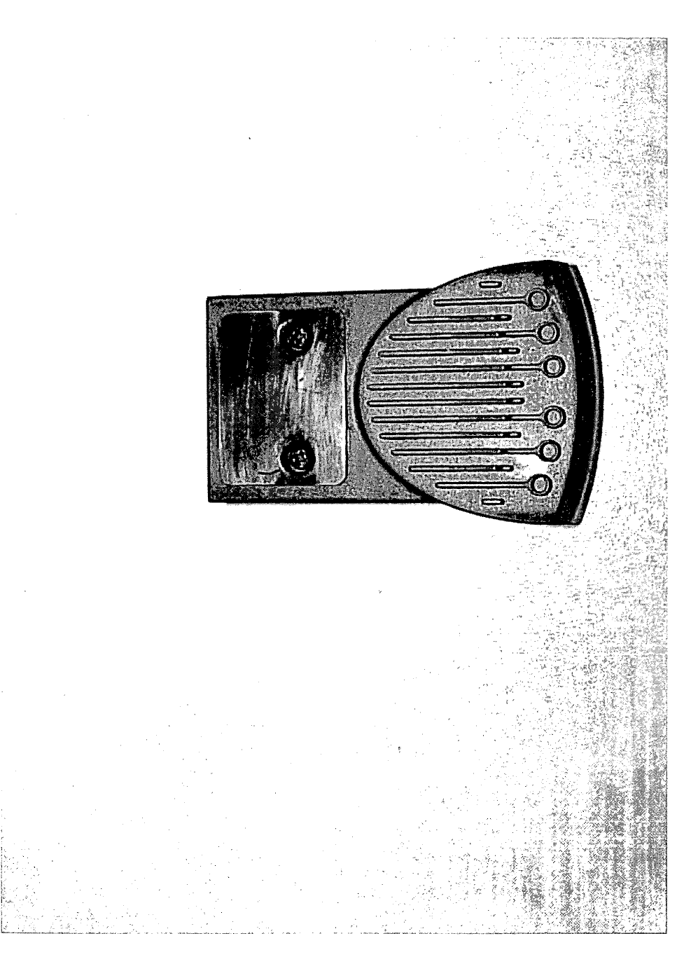

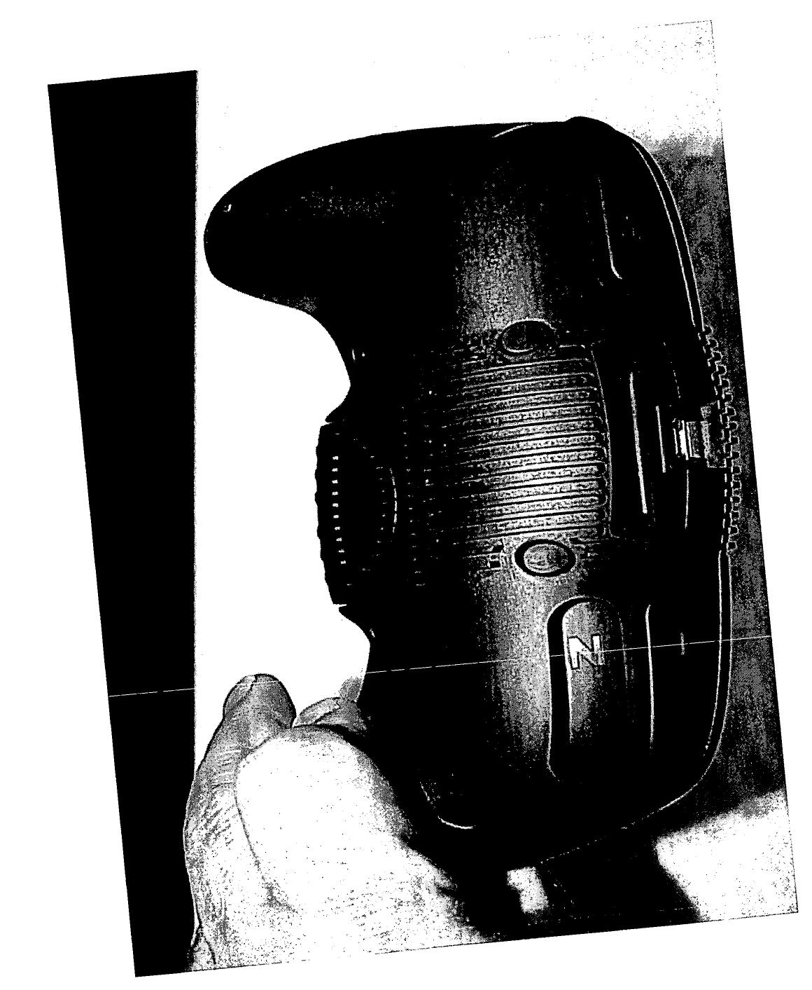

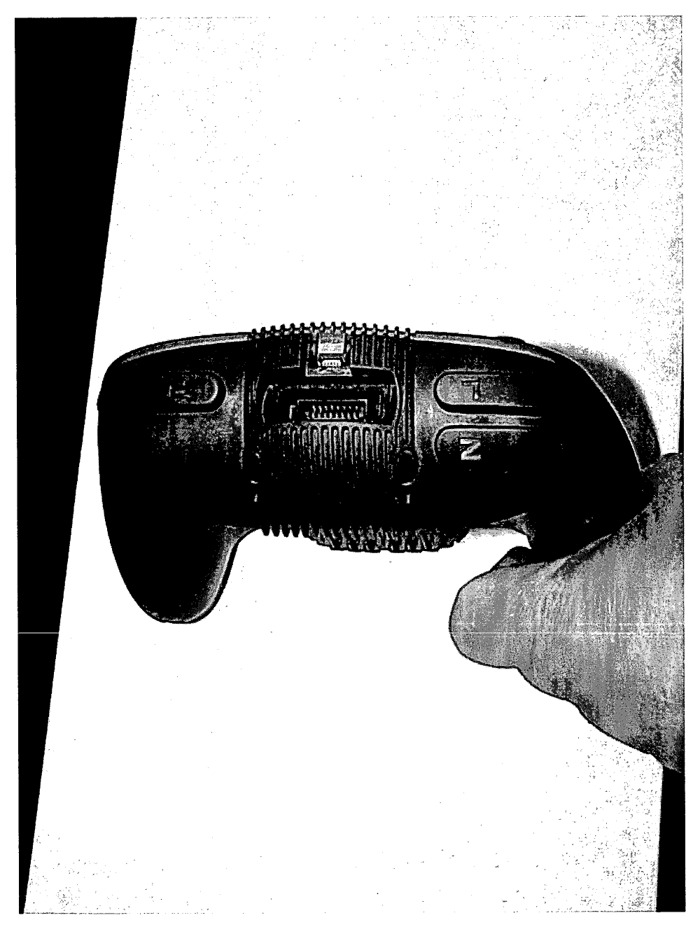

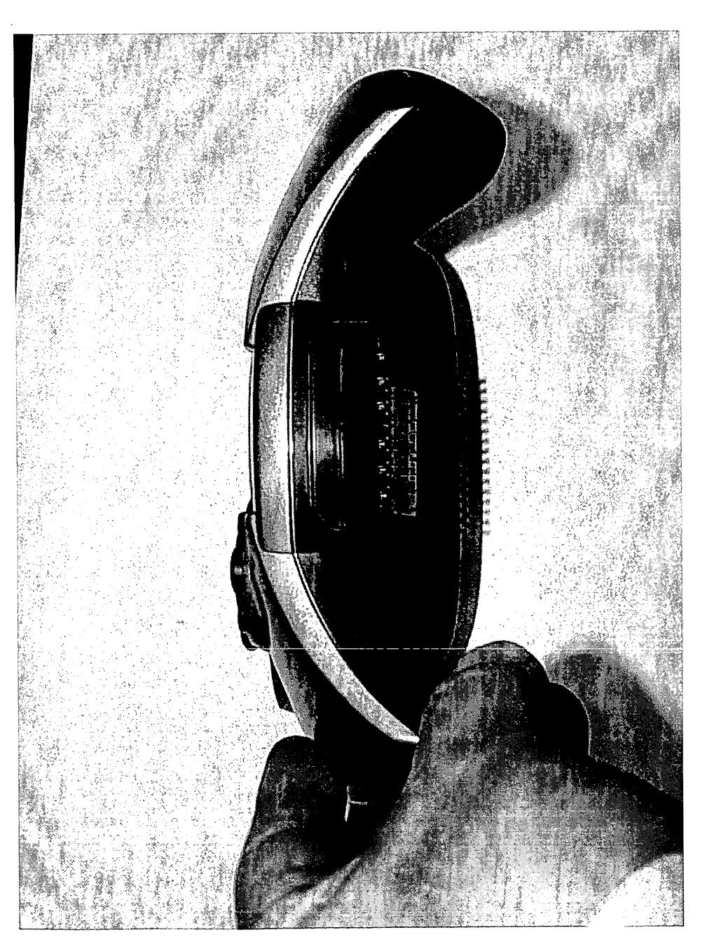

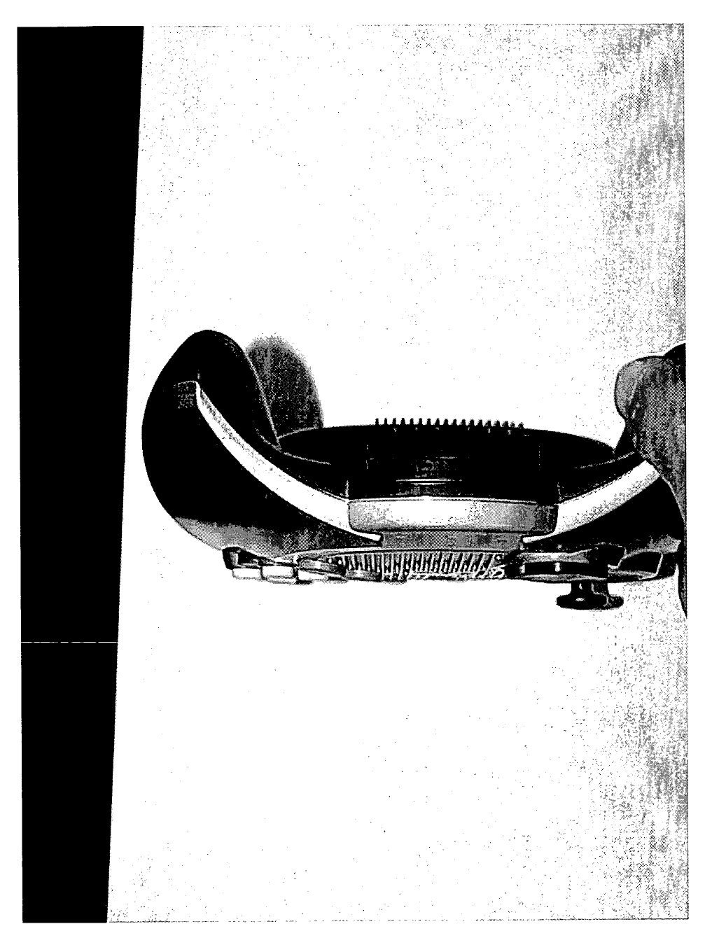

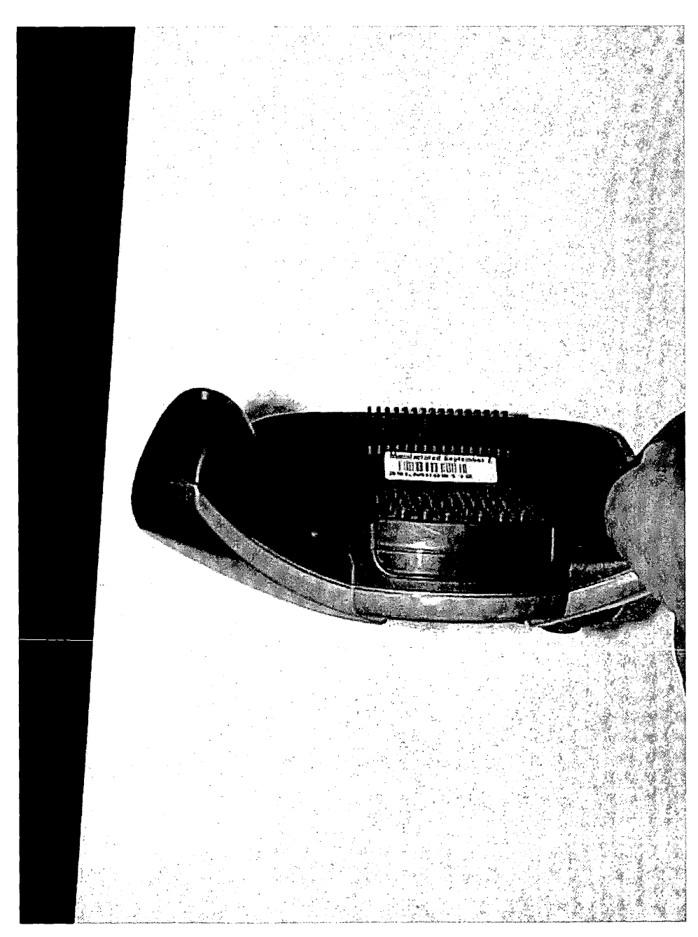

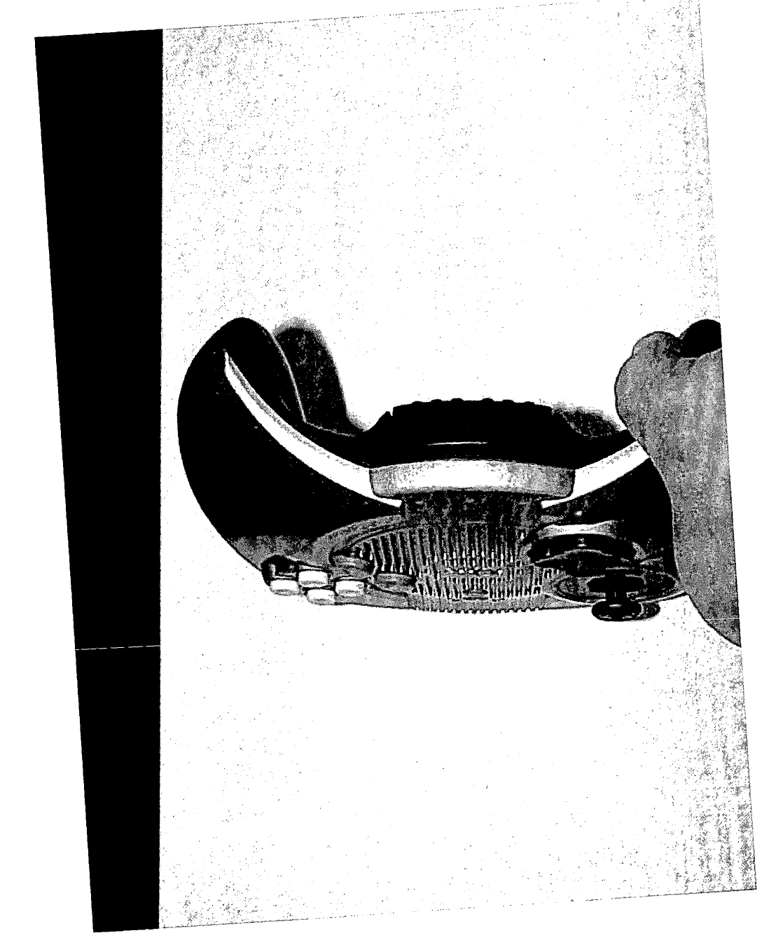

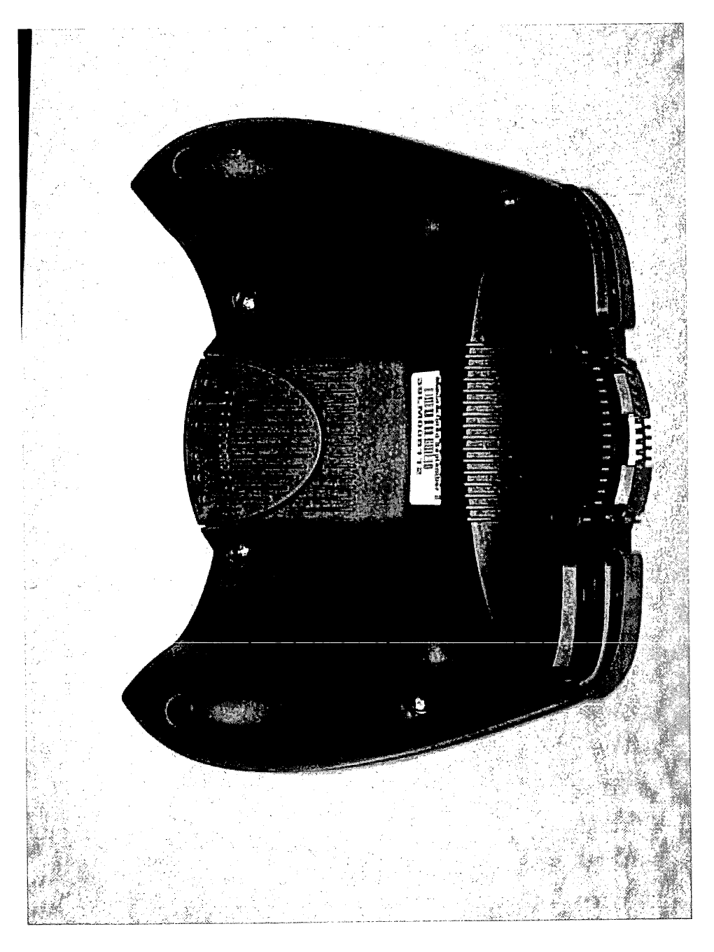

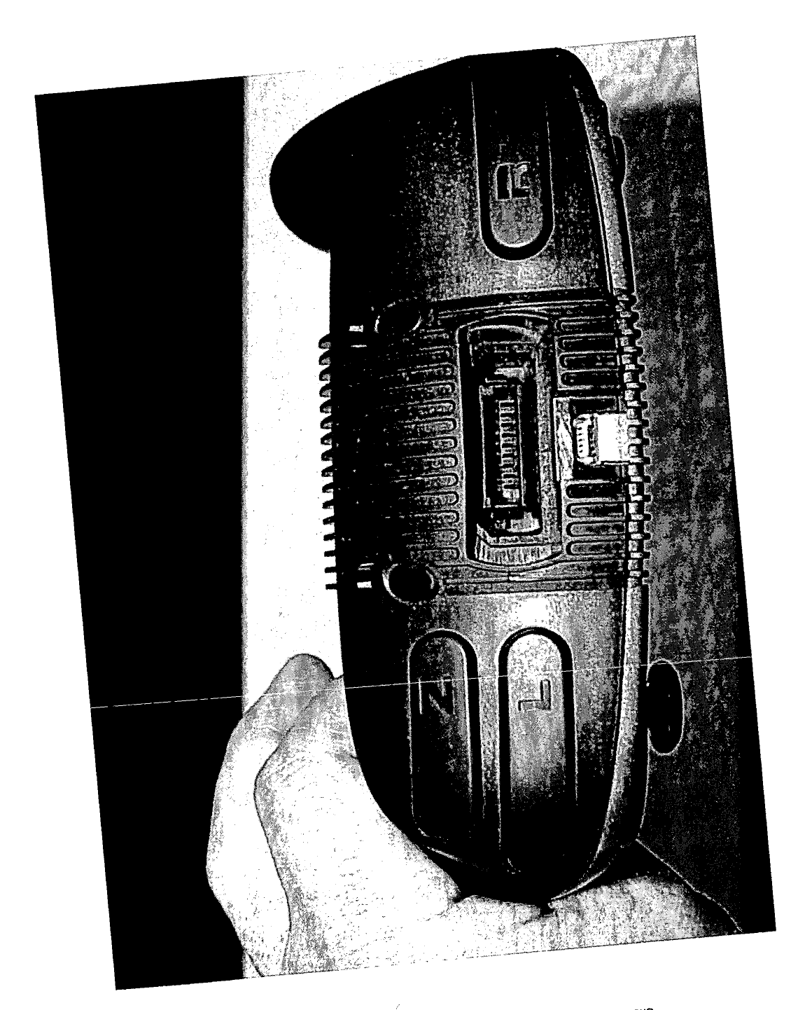

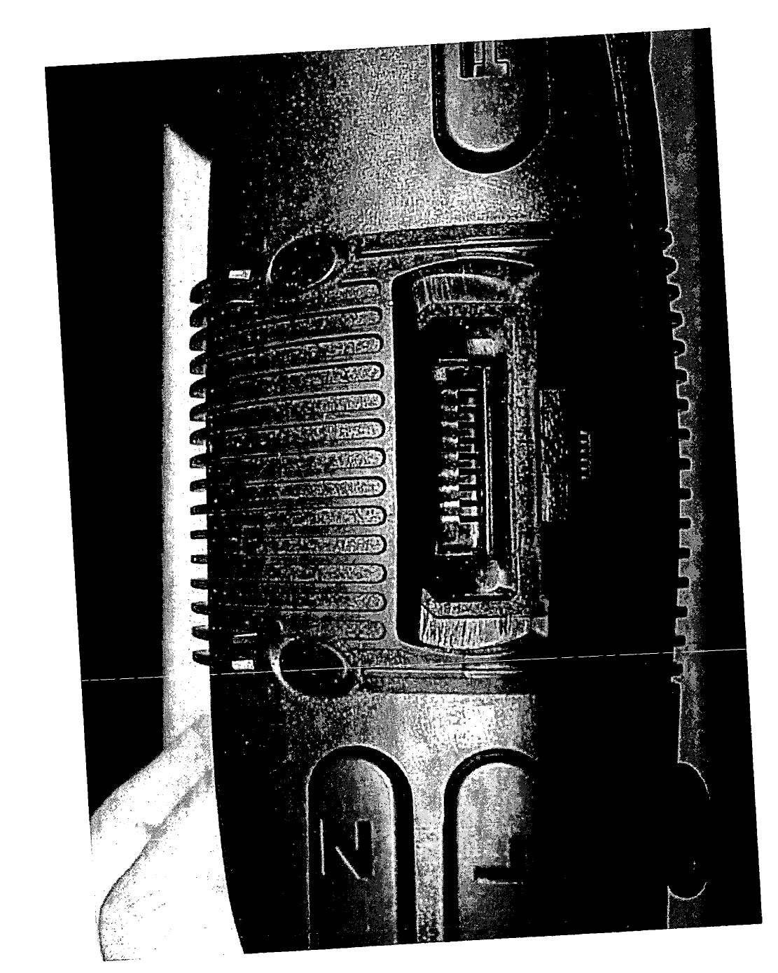

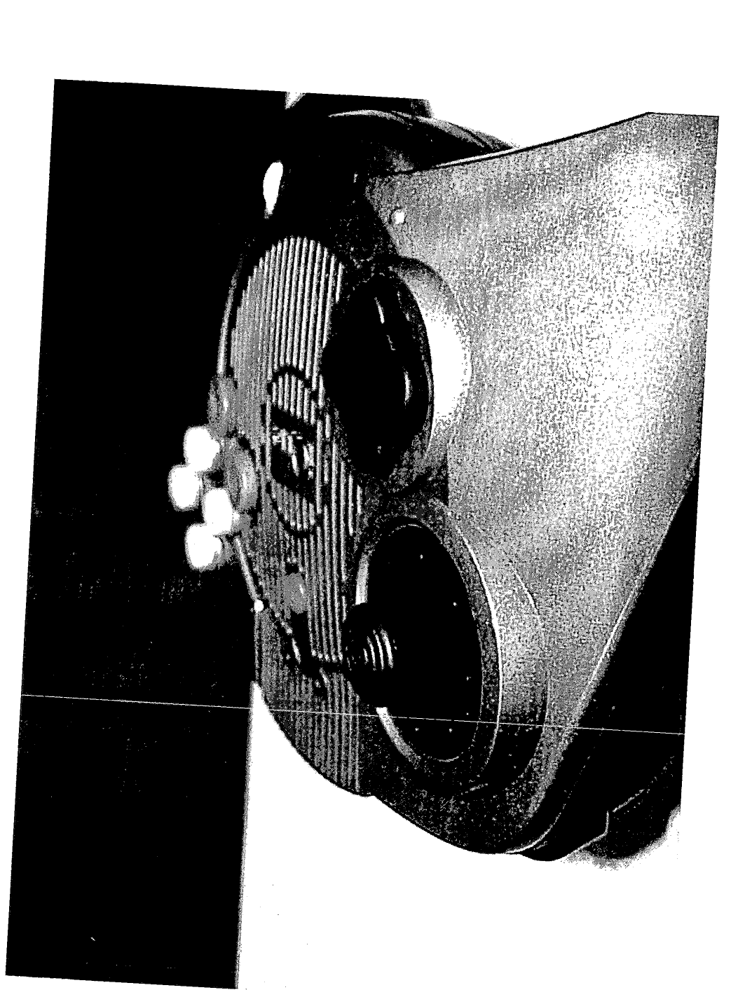

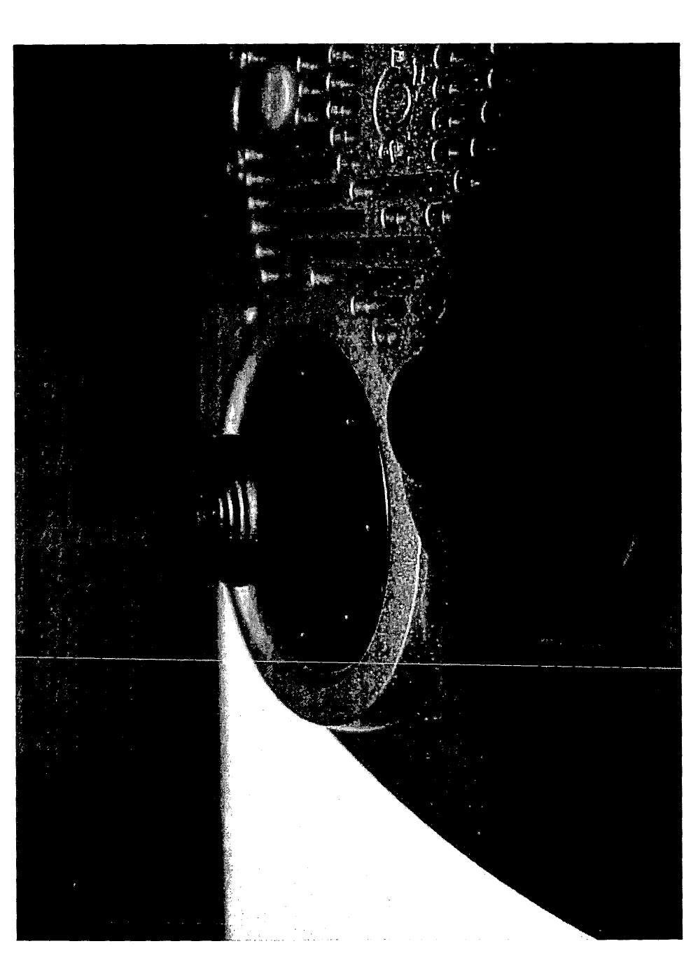

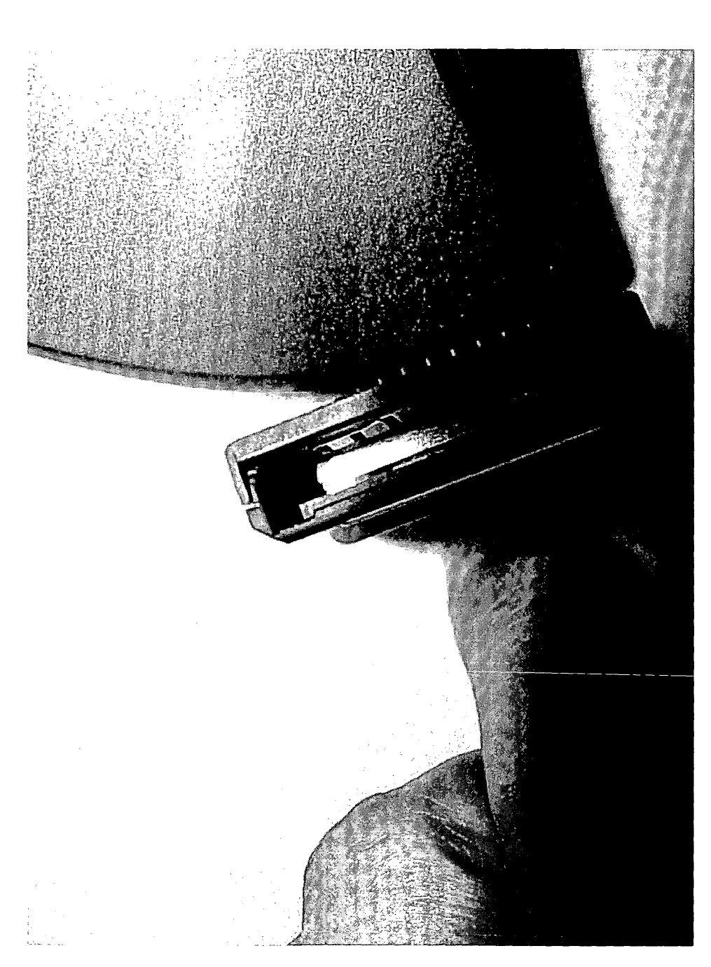

The control circuits 114 are further described herein with reference to FIG. 2.

In one embodiment, the removable storage element 115 includes at least some rewritable memory, such as for example NAND flash memory. With at least some rewritable memory, the removable storage element 115 can be dynamically updated by writing new information, such as for example when making a request for update from a server device (further described below) and receiving updated information from that server device. However, there is no particular requirement that the removable storage element 115 involves a rewritable memory. In some embodiments, the removable storage element 115 might be updated, dynamically or otherwise, by physically replacing the removable storage element 115 with a different removable storage element 115 including different information.

Supplemental Consoles

FIG. 1 also shows the system optionally including one or more supplemental consoles.

The system 100 optionally includes one or more supplemental consoles 140. Each supplemental console 140 includes a handheld controller housing 141, and a set of player inputs 142, similar to the integrated console/controller 110. However, there is no particular requirement that any supplemental console 140 be identical or even similar in design or user interface to the integrated console/controller 110. In alternative embodiments, each supplemental console 140 might be substantially distinct, such as for example by being adapted to a selected game or to a selected player role in a multiplayer game.

A first supplemental console 140 can be optionally coupled to the integrated console/controller 110 using a substantially passive coupler 143 interposed between the integrated console/controller 110, the television 120, and the first supplemental console 140. This has the effect that the first supplemental console 140 is capable of exchanging control signals between its player inputs 142 and the integrated console/controller 110, similar to a case where the supplemental console 140 was coupled to a controller without an integrated console.

In one embodiment, the passive coupler 143 includes a television signal splitter. However, there is no particular requirement for the passive coupler 143 to include an analog signal splitter. In alternative embodiments, the substantially passive coupler 143 might include a digital signal router or a portion of a digital signal routing framework.

A second supplemental console 140 can be optionally coupled to the integrated console/controller 110 using a direct link 144 between the integrated console/controller 110 and the second supplemental console 140. This has the effect that the second supplemental console 140 is capable of exchanging control signals between its player inputs 142 and the integrated console/controller 110, similar to a case where the supplemental console 140 was coupled to a controller without an integrated console.

In one embodiment, the direct link 144 includes an electrical cable, an IR (infrared) link, or an RF (radio frequency) link. However, there is no particular requirement for the direct link 144 to be physically direct without any interposed devices. In alternative embodiments, the direct link 144 might include a digital signal router or a portion of a digital signal routing framework.

After reading this application, those skilled in the art would recognize that providing either the first supplemental console 140 or the second supplemental console 140, and coupling at least one of them to the integrated console/controller 110, has the effect that the system 100 can support a multiplayer game, or another game having multiple consoles.

Interaction with Workstation

FIG. 1 also shows the system 100 optionally including one or more interactive workstations.

The system 100 optionally includes one or more interactive workstations 150. In one embodiment, each such workstation 150 includes a general purpose computing device, program and data memory, mass storage, and a communication link 160 with a remote device 170, such as for example a PC desktop or laptop computer with an Internet connection. However, there is no particular requirement that any workstation 150 include a general purpose computing device. In alternative embodiments, one or more workstations 150 might include substantially special purpose computing devices, such as for example a computing device optimized as a graphical display element in a selected game, or a computing device optimized as a server for a selected game.

For example, not intended to be limiting in any way, in alternative embodiments, the integrated console/controller 110 may be coupled directly to a network adapter 151, which is itself coupled to the communication link 160. The network adapter 151 might include a network router, broadband modem, such as for example a DSL modem or a cable modem, or a PSTN (public switched telephone network) modem, such as for example a V.90 modem. As described below, in one embodiment the integrated console/controller 110 includes a USB port or a similar communication link with the workstation 150. In alternative embodiments, that USB port or similar communication may be coupled in addition or instead to the network adapter 151.

In one embodiment, the integrated console/controller 110 includes a USB (universal serial bus) port or a similar communication link with the workstation 150, with the effect that the integrated console/controller 110 can exchange information with the workstation 150. As described above, the workstation 150 might provide supplemental computing for the game, or as described below, the workstation 150 might provide an indirect connection, using the communication link 160, to the remote device 170 capable of supplemental computing for the game.

Remote Interaction

FIG. 1 also shows the system 100 optionally including one or more remote players.

The system 100 optionally includes one or more remote players 171 disposed at one or more remote devices 170, such as for example if the one or more remote devices 170 themselves include integrated console/controllers 110 or supplemental consoles 140 disposed at substantially remote locations.

In a first embodiment, the remote players 171 can use the remote devices 170 to exchange information with the integrated console/controller 110, such as for example using the communication link 160 and the one or more interactive workstations 150.

In a second embodiment, the remote players 171 can use the remote devices 170 to exchange information with a game server 172, which itself exchanges information with the integrated console/controller 110, such as for example using the communication link 160 and the one or more interactive workstations 150.

After reading this application, those skilled in the art would recognize that providing a connection between the remote players 171 and the integrated console/controller 110, either more directly using the workstation 150 or less directly using the remote server 172, has the effect that the system 100 can support a game including remote players, or another game having remote consoles.

After reading this application, those skilled in the art would recognize that providing a connection between the remote players 171 and the integrated console/controller 110, either more directly using the workstation 150 or less directly using the remote server 172, has the effect that the system 100 can also support a game contest, such as for example where each player plays individually, and can be responsive to aggregates or statistical measures of a group of players, such as for example a high score, a median score, or an aggregate score for a team of players.

Integrated Console/Controller (Circuits)

FIG. 2 shows a block diagram of an example integrated console/controller.

A set of control circuits 114 is disposed in the housing 111, and includes a storage interface 210 capable of being coupled to the removable storage element 115, a controller input interface 220 capable of being coupled to the player inputs 112, an audio/video interface 230 capable of being coupled to the display device 120, an optional power interface 240 capable of being coupled to the optional power supply 130, an optional controller interface 250 capable of being coupled to one or more supplemental controllers 140, an optional workstation interface 260 capable of being coupled to one or more workstations 150, a memory 270 and its associated memory interface, and a computing device 280 capable of executing or interpreting instructions from the memory 270 to control the integrated console/controller 110.

The storage interface 210 might include a known interface for operating in combination or conjunction with a NAND flash cartridge or another type of removable storage element 115.

Similarly, the controller input interface 220 might include a known interface for operating in combination or conjunction with the player inputs 112.

Similarly, the audio/video interface 230 might include a known interface for operating in combination or conjunction with the display device 120, such as for example a direct audio or video output interface. As described above, the integrated console/controller 110 may alternatively or in addition include a speaker or other audio output, so there is no particular requirement for actual audio output to the display device 120.

Similarly, the optional power interface 240 might include a known interface for operating in combination or conjunction with the optional power supply 130. As described above, the integrated console/controller 110 may alternatively or in addition include a battery or other self-powering element, so there is no particular requirement for an actual power interface 240.

Similarly, the optional controller interface 250 might include a known interface for operating in combination or conjunction with one or more supplemental controllers 140. In one embodiment, the controller interface 250 includes one or more relatively low-speed bidirectional serial ports.

Similarly, the optional workstation interface 260 might include a known interface for operating in combination or conjunction with one or more workstations 150. In one embodiment, the workstation interface 260 includes a set of dual mode USB ports, capable of being controlled by the workstation 150 as a communication link. In alternative embodiments, the workstation interface 260 may include a extendible bus, such as a mezzanine bus such as a PCI bus extension.

Similarly, the optional workstation interface 260 might include a known interface for operating in combination or conjunction with one or more workstations 150. In one embodiment, the workstation interface 260 includes a set of dual mode USB ports, capable of being controlled by the workstation 150 as a communication link. In alternative embodiments, the workstation interface 260 may include a extendible bus, such as a mezzanine bus such as a PCI bus extension.

The memory 270, its associated memory interface, and the computing device 280 operate in combination or conjunction, with the effect that the computing device 280 executes or interprets instructions from the memory 270 to control the integrated console/controller 110 as described herein.

Integrated Console/Controller (Design)

FIGS. 3A-3AJ (collectively referred to herein as FIG. 3) show a design of an example integrated console/controller.

### Alternative Embodiments

Although preferred embodiments are disclosed herein, many variations are possible which remain within the concept, scope, and spirit of the invention. These variations would become clear to those skilled in the art after perusal of this application.

After reading this application, those skilled in the art would recognize that the techniques described herein provide an enabling technology, with the effect that heretofore advantageous features can be provided that heretofore were substantially infeasible.

After reading this application, those skilled in the art will recognize that these alternative embodiments and variations are illustrative and are intended to be in no way limiting.

1. A system including
an integrated element capable of combining the capabilities of a console and controller;
the integrated element being included in a housing capable of being hand-held;
the housing including a location capable of receiving a cartridge, the cartridge being capable of being inserted and removed.

2. A system as in claim 1, wherein the cartridge includes at least some rewritable memory elements.

3. A system as in claim 1, wherein the software includes at least some elements that have been dynamically replaced or upgraded.

4. A system as in claim 1, including
a communication link to at least one general purpose computing device; and
the software including at least one element capable of supporting interactive communication between the integrated element and at least one of: a network router, a remote game console, a remote output device, or a server.

5. A system as in claim 4, wherein the communication link includes an audio or video output from the integrated element to a substantially remote output device.

6. A system as in claim 4, wherein the communication link includes an input from a substantially remote supplemental console to the integrated element.

7. A system as in claim 4, wherein the communication link is capable of supporting a dynamic replacement or update of at least one software element at the integrated element.

8. A system as in claim 4, wherein the software includes at least one element capable of supporting a game with multiple consoles.

9. A system as in claim 4, wherein the software includes at least one element capable of supporting a contest among multiple players, the contest being adjudicated at either one of the integrated elements, or at a server.

10. A system as in claim 9, wherein the contest includes a memory having an aggregate measure or a statistical measure of scores achieved by multiple players, each one of the multiple players being associated with an instance of a game.

11. A system as in claim 1, including a communication link to at least one supplemental console, the communication link being capable of supporting communication between the supplemental console and at least one of: an output device or the integrated element.

12. A system as in claim 11, wherein the communication link includes a direct audio or video output from the supplemental console to the output device.

13. A system as in claim 11, wherein the communication link includes an input from the supplemental console to the integrated element.

14. A system as in claim 11, wherein the software includes at least one element capable of supporting a game with multiple consoles.

15. A system as in claim 11, wherein the software includes at least one element capable of supporting a multiplayer game.

16. A system as in claim 1, including
at least one input device;
a memory including software capable of receiving inputs from that at least one input device;
the software including elements capable of generating a signal capable of being communicated to an output device;
a secure processor capable of executing or interpreting at least some instructions in the software, and capable of controlling operation of the software, whereby only authorized software can be executed or interpreted.

17. A system as in claim 16, wherein at least some of the memory is disposed in the cartridge.

18. A system as in claim 16, wherein the cartridge includes at least some information capable of authenticating the software.

19. A system as in claim 16, wherein the cartridge includes at least some information capable of replacing or upgrading the software.

20. A design of an integrated console/controller, essentially as shown.
